(19) United States
(12) Patent Application Publication
(10) Pub. No.: US 2013/0149486 A1
(43) Pub. Date: Jun. 13, 2013

(54) METHOD AND DEVICE FOR THINLY COATING A COMPONENT ON ALL SIDES, IN PARTICULAR A DECORATIVE ELEMENT, AND COMPONENT WITH A THIN COATING

(71) Applicants: Norbert Müller, Aschaffenburg (DE); Andreas Hans, Aschaffenburg (DE); Bernhard Kempf, Kleinwallstadt (DE); Martin Sauer, Hosbach (DE); Achim Hartlaub, Grosswallstadt (DE)

(72) Inventors: Norbert Müller, Aschaffenburg (DE); Andreas Hans, Aschaffenburg (DE); Bernhard Kempf, Kleinwallstadt (DE); Martin Sauer, Hosbach (DE); Achim Hartlaub, Grosswallstadt (DE)

(21) Appl. No.: 13/818,628

(22) PCT Filed: Jul. 14, 2011
(86) PCT No.: PCT/EP2011/062084

§ 371 Date: Feb. 22, 2013

(30) Foreign Application Priority Data
Aug. 25, 2010 (DE) 10 2010 039 768.7
Aug. 25, 2010 (DE) 20 2010 011 840.9

(51) Int. Cl. B29C 70/70

(52) U.S. Cl. CPC B29C 70/70
USPC 428/76; 264/279; 425/447

(57) ABSTRACT

A method and a device for thinly coating a component on all sides are provided. A single layer is applied onto the component by casting in a casting mold, wherein during the casting process the material to be applied moves as laminar flow in the region of the decorative element. For this purpose, a casting mold consisting of a lower and an upper part is provided, in which proceeding from at least one sprue in the upper part to the side of the component to be coated a runner extends in direction of the component to be coated for filling the casting material into the casting mold, wherein in the runner in the vicinity of the component to be coated a retaining groove is provided for distributing the casting material across the width, and wherein the runner has a reduced passage subsequent to the retaining groove.

The invention relates to a method for thinly coating a component on all sides, in particular a decorative element, according to the generic part of claim 1, a device for thinly coating a component on all sides, in particular a decorative element according to the generic part of claim 5, and to a component with a thin coating according to the generic part of claim 13.

Decorative elements in particular for vehicle interiors generally are very susceptible to damages and soiling. Therefore, films or also noble-wood veneers subsequently are coated with a clear or also slightly tinted protective paint.

To achieve the necessary brilliance, it is known from practice to apply the paints in several layers. Such multilayer paintwork is effected either with intermediate drying or possibly intermediate sanding or by wet-on-wet painting, in which the material is allowed to gel between the individual applications and is painted onto the still sticky layer. With painting methods it is possible to coat decorative elements on all sides.

The disadvantage of these methods consists in that painting several times is labor-intensive. Furthermore, the paints contain solvents. Since the paintwork generally is effected by spraying, material losses are obtained, as on spraying the surroundings of the workpiece also is sprayed with paint. In addition, no sharp design edges can be achieved.

From DE 103 09 814 B3 it is known to provide components with a compact polyurethane sealing layer. For this purpose, the component is inserted into a molding tool. In the closed condition of the mold, a gap is present between the surface of the component to be coated and the opposed inner wall of the mold. The material then is cast on either from one side or centrally. Air bubbles are pushed along in front of the casting material and then can escape laterally.

The disadvantage of this method consists in that coating of the workpiece only is possible on one side.

From the Utility Model DE 297 14 358 U1 it is furthermore known to completely sheathe automotive accessories, in particular steering wheels. In doing so, a component, e.g. a skeleton for a hand steering wheel, is inserted into a mold and cast in a transparent, compact, colorless urethane plastic. These are layers with a thickness of at least several millimeters, i.e. not layers which are comparable with coats of paint.

It is the object underlying the invention to surround components with a thin, in particular transparent protective layer on all sides, as seen in cross-section, with less expenditure of work than in painting and in a high quality.

In accordance with the invention, the object is solved with a method according to claim 1, with a device according to claim 5 and with a component according to claim 13.

The method according to the invention for thinly coating a component on all sides, in particular a decorative element, is characterized in that a single layer is applied onto the component by casting in a casting mold, wherein during the casting process the material to be applied moves as laminar flow. The layer thickness is 0.5-1.5 mm and preferably 1.0 mm.

Whereas with flat parts, in which only the surface is coated, air bubbles enclosed during casting are pushed along in front of the casting material, and can escape again at the end, this is not the case with a component thinly coated on all sides, e.g. with a decorative element. In this case, the casting material must again flow into each other, as it must enclose the component on all sides. It has now been found that a laminar flow of the casting material is required to avoid the inclusion of air bubbles on the decorative layer and hence to avoid scrap.

It is expedient that the material to be applied is under overpressure in the casting mold. Hence it becomes possible that possibly remaining air bubbles are compressed.

It is furthermore expedient that to the side of the component at a lateral distance to the same the material to be applied is introduced into the casting mold in its middle region. It thereby is achieved that to the side of the component the material to be applied must approximately horizontally flow through a predetermined distance, in which the initially turbulent flow is converted into a laminar flow. The material to be applied reaches the middle region of the component and is deflected upwards and downwards at the component and subsequently completely flows around the component.

A device for coating a component on all sides, in particular a decorative element, and in particular for carrying out the method described above is characterized in that a casting mold consisting of a lower and an upper part is provided, that proceeding from at least one sprue in the upper part to the side of the component to be coated for filling the casting material into the casting mold a runner extends in direction of the component to be coated, that in the runner in the vicinity of the component to be coated a retaining groove is provided for distributing the casting material across the width, and that subsequent to the retaining groove the runner has a reduced passage. Furthermore, the runner is tapered in height and increased in width in direction of the decorative element to be coated, by largely maintaining the flow cross-section.

After filling into the sprue, the casting material thus flows through the approximately horizontally extending runner, in which the turbulent flow initially present after filling largely is converted into a laminar flow. The retaining groove and the adjoining reduced passage serve to completely convert the flow into a laminar flow. With the particular design of the runner, it is achieved that as much material as possible can be introduced into the casting mold.

It is expedient that between the component to be coated and the casting mold a gap is provided, which corresponds to the final layer thickness on the component. It thereby is achieved that the final geometry of the component is formed by the casting mold. After mechanically removing the sprue, a subsequent removal of material is not required, except for the removal of the release agent required during casting by polishing. The removal of the release agent is metrologically negligible.

It is furthermore expedient that in flow direction behind the component the casting mold has a gap between the lower and the upper part. This results in an overpressure in the casting mold, which leads to the compression of air bubbles possibly still present. The gap preferably has a cross-section which corresponds to the cross-section of the passage behind the retaining groove.

For venting the cavity it was found to be advantageous that behind the gap at least one overflow channel is provided, which can be shorter than the component to be coated.

It is possible that a sprue is provided in the middle width region of the component to be coated or that a plurality of sprue points are provided distributed across the width region of the decorative part to be coated.

In accordance with the invention, a component according to the invention with a thin protective layer is characterized in that as seen in cross-section a single-layer cast protective layer is provided, which surrounds the component on all sides. A component with a thin cast coating on all sides is not known so far. The reason for this can be seen in that during casting it has so far been difficult to remove air bubbles from a thin cast and coherent layer, since the material must again flow into each other during casting.

When the component is a decorative element, the same includes a decorative layer which is surrounded by the cast protective layer. In a decorative layer, air bubbles in the coating are particularly disturbing. As component, e.g. at least one portion of a steering wheel can be provided.

The protective layer has a thickness between 0.5 and 1.5 mm and preferably a thickness of 1 mm.

The protective layer preferably consists of 2-component polyurethane.

The advantage of such a cast protective layer consists in that the components can be coated on all sides with zero emission. As compared to painting, shorter cycle times are obtained. The layer does not turn yellow, which is the case with many clear coats, in particular with polyester.

The invention will be explained in an exemplary embodiment with reference to the drawings, in which:

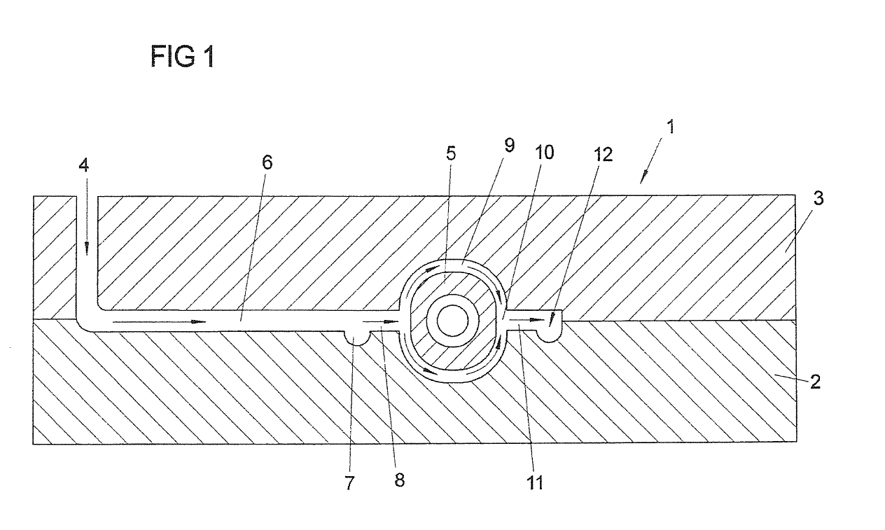

FIG. 1 shows a cross-section through a casting mold;

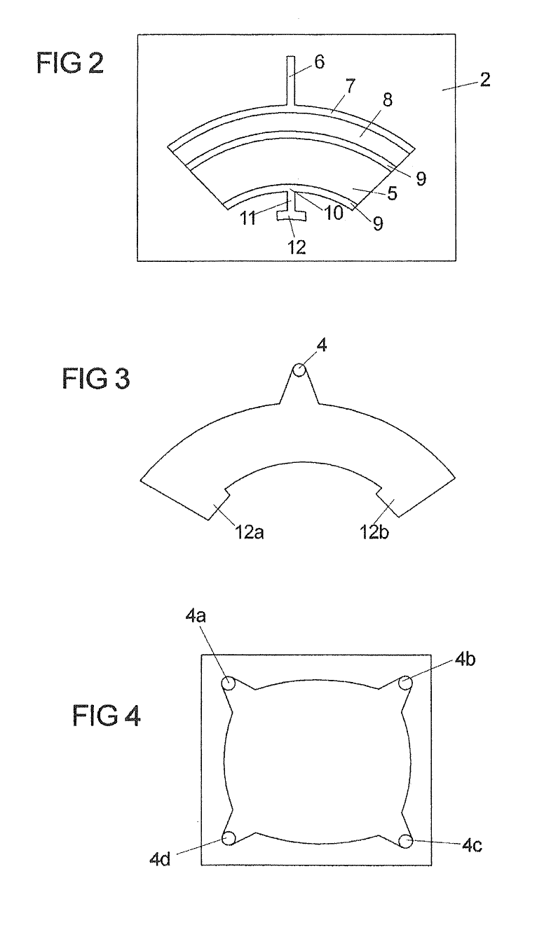

FIG. 2 shows a top view of the lower part of the casting mold of FIG. 1 in a reduced scale as compared to FIG. 1;

FIG. 3 shows a top view of a portion of a casting mold with a sprue;

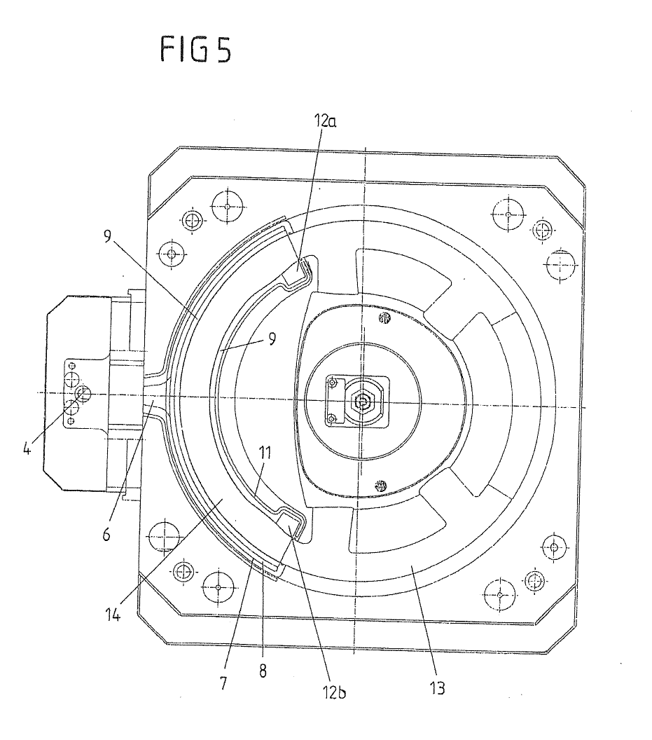

FIG. 4 shows a top view of a casting mold with four sprue points;

FIG. 5 shows a top view of the lower part of a casting mold for the partial coating of a steering wheel;

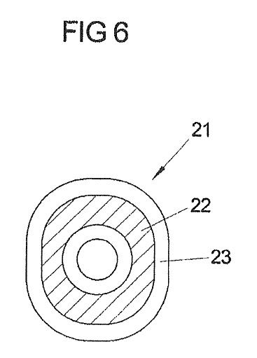

FIG. 6 shows a coated portion of a steering-wheel rim in cross-section.

The casting mold 1 shown in FIG. 1 consists of a lower part 2 and an upper part 3. In the upper part a sprue 4 is provided, through which casting material, which with a decorative element 5 as component to be coated is to be coated, is filled into the casting mold. The sprue 4 is arranged to the side of the decorative element 5 to be coated. An almost horizontally extending runner 6 adjoins the sprue extending vertically downwards. To be able to introduce as much casting material as possible into the casting mold, the runner 6 is conically tapered in direction of the decorative element 5. Proceeding from the runner 6, the casting material is distributed across the width of the decorative element 5 to be coated. For this purpose, a retaining groove 7 is provided in direct vicinity of the decorative element 5 for distributing the casting material across the width. The retaining groove 7 is followed by a reduced passage 8. The reduced passage 8 and also the retaining groove 7 serve to eliminate the turbulences not yet eliminated in the runner 6, so that a laminar flow is present at the end of the passage 8. In addition, air bubbles contained in the casting material are compressed by the retaining groove 7 and the passage 8.

The casting material flowing laminarly after overcoming the retaining groove 7 and the passage 8 flows into a casting gap 9 between the decorative element 5 and the casting mold 1 and encloses the decorative element 5 from all sides. As shown in FIG. 1, the casting material flows both downwards and upwards in the casting gap 9. In the region 10 of the confluence of the casting material, the casting mold is not closed, but has a minimal gap 11 between the lower part 2 and the upper part 3 of the casting mold 1. The cross-section of the gap 11 corresponds to that of the passage 8 behind the retaining groove 7. However, the cross-section can also be smaller. As a result of the gap 11 an overpressure is obtained in the casting mold 1, which leads to the compression of air bubbles possibly still present.

For venting the cavity an overflow channel 12 behind the gap 11 was found to be advantageous, which however need not extend across the entire width of the decorative element, but only across a few centimeters.

FIG. 2 shows the decorative element 5 in its entire width in the lower part 2 of the casting mold. Furthermore, the lower region of the runner 6 is visible, which is followed by the retaining groove 7 which distributes the casting material across the entire width of the decorative element, so that it can subsequently flow through the passage 8 to the casting gap 9 on the entire width of the decorative element 5.

Furthermore, FIG. 2 shows the region 10, the adjoining gap 11 and the overflow channel 12. It can be seen that the overflow channel 12 only has a small width.

FIG. 3 schematically shows a portion of a casting mold with a sprue 4 in the middle width region of the decorative element, as it is provided in the embodiment shown in FIGS. 1 and 2. In contrast to the embodiment shown in FIG. 2, there is not provided a central overflow channel 12, but two overflow channels 12a, 12b are present at the ends of the decorative part not shown here.

The casting mold schematically shown in FIG. 4 includes four sprue points 4a, b, c, d and is provided for coating a non-illustrated ring-shaped component.

FIG. 5 shows a lower part 2 of a casting mold, which is provided for the partial coating of a steering wheel. In this lower part, a steering wheel 13 is located, whose steering-wheel rim is to be coated in a portion 14. The casting mold is formed such that the casting gap 9 shown in FIGS. 1 and 2 with the associated runner 6 and the sprue 4 as well as the retaining groove 7, the passage 8, the gap 11 and the overflow channels 12a, 12b are provided only in this portion 14.

In a correspondingly modified casting mold it is also possible to coat the entire steering-wheel rim of a steering wheel, and in this case, as is shown in FIG. 4, it is expedient to provide several, preferably four, sprue points.

In the exemplary embodiment of FIG. 6, a coated portion of a steering-wheel rim is shown in cross-section. The steering-wheel rim 21 is provided with a decorative layer 22 which is to be protected. For this purpose, a cast protective layer 23 is provided, which as seen in cross-section completely surrounds the decorative layer. This protective layer can be provided both on a limited portion of a steering-wheel rim and on the entire steering-wheel rim.

1. A method for providing a thin, in particular transparent coating of a component, in particular a decorative element, on all sides, wherein a single layer is applied onto the component by casting in a casting mold, wherein during the casting process the material to be applied moves as laminar flow in the region of the decorative element, wherein the material to be applied is introduced into the casting mold to the side of the component in its middle region and wherein the material is introduced into the casting mold with a lateral distance to the component.

2. The method according to claim 1, wherein the material to be applied is under overpressure in the casting mold.

3. (canceled)

4. (canceled)

5. A device for providing a thin, in particular transparent coating of a component, in particular a decorative element, on all sides and in particular for carrying out the method according to claim 1, wherein a casting mold consisting of a lower and an upper part is provided, wherein proceeding from at least one sprue in the upper part to the side of the component to be coated a runner extends in direction of the component to be coated for filling the casting material into the casting mold, wherein in the runner in the vicinity of the component to be coated a retaining groove is provided for distributing the casting material across the width, wherein the runner has a reduced passage subsequent to the retaining groove, wherein the runner is tapered in height and increased in width in direction of the component to be coated, by largely maintaining the flow cross-section, wherein in flow direction behind the component the casting mold has a gap between the lower and the upper part, wherein behind the gap at least one overflow channel is provided and wherein the overflow channel is shorter than the component to be coated.

6. The device according to claim 5, wherein between the component to be coated and the casting mold a casting gap is provided, which corresponds to the final layer thickness on the component.

7. (canceled)

8. The device according to claim 5, wherein the gap has a cross-section which corresponds to the cross-section of the passage behind the retaining groove.

9. (canceled)

10. (canceled)

11. The device according to claim 5, wherein a sprue is provided in the middle width region of the component to be coated.

12. The device according to claim 5, wherein a plurality of sprue points are provided distributed across the width region of the component to be coated.

13. A component with a thin protective layer, wherein as seen in cross-section a single-layer cast protective layer is provided, which surrounds the component on all sides.

14. The component according to claim 13, wherein the component is a decorative element which includes a decorative layer which is surrounded by the cast protective layer.

15. The component according to claim 14, wherein as the component at least one portion of a steering-wheel rim is provided.

16. The component according to claim 13, wherein the protective layer has a thickness between 0.5 and 1.5 mm.

17. The component according to claim 13, wherein the protective layer has a thickness of 1 mm.

18. The component according to claim 13, wherein the protective layer is made of 2-component polyurethane.
